(19) United States
(12) Patent Application Publication
(10) Pub. No.: US 2016/0036371 A1
(43) Pub. Date: Feb. 4, 2016

(54) ELECTRIC POWER STEERING SYSTEM AND VEHICLE CONTROL SYSTEM INCLUDING THE ELECTRIC POWER STEERING SYSTEM

(71) Applicant: DENSO CORPORATION, Kariya-city (JP)

(72) Inventor: Masashi Yamasaki, Obu-city (JP)

(21) Appl. No.: 14/812,886

(22) Filed: Jul. 29, 2015

(30) Foreign Application Priority Data
Jul. 31, 2014 (JP) 2014-156476

(51) Int. Cl. H02P 29/02; B60R 16/03; H02P 25/22; B62D 5/04

(52) U.S. Cl. CPC H02P 29/022; B62D 5/046; B60R 16/03; H02P 25/22

(57) ABSTRACT

An electric power steering system includes an electric power steering device. The electric power steering device includes an electric motor, a controller controlling the motor, and two power supply connectors that assist a steering operation of a vehicle. The electric power steering system also includes a first power supply supplying power to a first connector, a second power supply supplying power to a second connector and to other in-vehicle devices other than the electric power steering device, and a power switcher provided en route to the controller, to electrically connect the first power supply to the controller when power supply from the first power supply is normal, and to electrically connect the second power supply to the controller when the power supply from the first power supply is abnormal.

### CROSS REFERENCE TO RELATED APPLICATION

The present application is based on and claims the benefit of priority of Japanese Patent Application No. 2014-156476, filed on Jul. 31, 2014, the disclosure of which is incorporated herein by reference.

### TECHNICAL FIELD

The present disclosure generally relates to an electric power steering system and a vehicle control system including such an electric power steering system.

### BACKGROUND INFORMATION

In a conventional electric power steering device, an electric motor for assisting a steering torque and a controller are used in combination, for an easy steering operation of a driver, i.e., for assisting a driver's operation of a steering wheel. Since the steering device controls a steering function of a vehicle, which is a basic and a critical functionality of the vehicle, the reliability of the steering device should be improved by system redundancy or the like.

For example, the electric power steering device disclosed in a patent document, Japanese patent document JP 2013-215040 A (Patent document 1), has plural sets of a winding and inverter combination, i.e., one winding group with plural winding wires of an electric motor is paired with one inverter, and a combination of a winding group and an inverter is provided in plural sets for constituting an electric power steering device.

According to the patent document 1, when one of the winding groups or one of the inverters fails, the electric motor in the steering device is still drivable by using the other set of the winding group and the inverter which is normally operating.

However, in the description of the patent document 1 or in other disclosures regarding the conventional technique, the redundancy only in the electric power steering device is discussed, without mentioning a redundancy of power supply, i.e., a supply of electric power, to the steering device.

Further, even when a power supply device having two power supply systems, i.e., a main supply and a sub-supply, is combined with the conventional electric power steering system, such a combination still suffers from the following problems.

The conventional electric power steering device is equipped with only one power supply connector. Therefore, the redundancy of the two power supply systems in one power supply device described above is lost in the course of combining two power supply lines extending from the two power supply systems into one line, i.e., two lines from each of the two power supplies integrated as one line for a connection to the only one connector. Thus, if the integrated, i.e., not-redundant, power supply line has a problem, the power supply to the electric power steering device is instantly lost.

Further, even with the in-vehicle power supply device having two systems, the power is usually supplied to many electric devices only from the main supply, thereby the operation of one device consuming a large electric power may affect the operation of the other devices, i.e., the electric power steering device exerting a full assist power causes a voltage drop or an electric current lowered for the other devices.

### SUMMARY

It is an object of the present disclosure to provide an electric power steering device with sufficiently redundant power supply for preventing a power fluctuation for the other electric devices sharing the power supply. The present disclosure also provides a vehicle control system having such an electric power steering device.

In an aspect of the present disclosure, an electric power steering system includes an electric power steering device that includes an electric motor, a controller controlling the motor, and two power supply connectors that assist a steering operation of a vehicle.

The electric power steering system also includes a first power supply supplying power to a first connector, a second power supply supplying power to a second connector and to other in-vehicle devices other than the electric power steering device, and a power switcher provided en route to the controller.

The power switcher electrically connects the first power supply to the controller when power supply from the first power supply is normal, and electrically connects the second power supply to the controller when the power supply from the first power supply is abnormal.

According to the above-mentioned configuration, a power supply line from the first power supply to the first power supply connector and a power supply line from the second power supply to the second power supply connector are provided as two completely separate lines. Therefore, when abnormality is caused in one of the two power supply lines, an electric power supply to the controller is continued by using another power supply line. Thus, the supply of the electric power to an electric power steering device may be sufficiently redundant.

According to the above-mentioned configuration, when the supply of the electric power from the first power supply is normal, an electric power is supplied to the electric power steering device from the first power supply, and an electric power is supplied to the other in-vehicle devices from the second power supply. That is, the supply of the electric power to the electric power steering device and the supply of the electric power to the other in-vehicle devices come from two separate power supplies. Therefore, even when the electric power steering device is consuming a big electric power for exerting the assist function, the other in-vehicle devices are prevented from suffering from the power fluctuation or the like. Further, in comparison to the conventional technique, in which the electric power steering device shares only one supply of the electric power with the other in-vehicle devices, the electric power steering device of the present disclose can allocate and consume a larger “share” of the electric power.

The electric power steering system of the present disclosure can be suitably used for a vehicle control system including a starter motor and a brake control.

### BRIEF DESCRIPTION OF THE DRAWINGS

Objects, features, and advantages of the present disclosure will become more apparent from the following detailed description made with reference to the accompanying drawings, in which:

FIG. 1 is a schematic diagram of an electric power steering system and a vehicle control system in a first embodiment of the present disclosure;

FIG. 2 is a top view of a drive unit in the electric power steering system in FIG. 1;

FIG. 3 is a sectional view along a III-III line in FIG. 2;

FIG. 4 is a schematic diagram of the electric power steering system and the vehicle control system in a second embodiment of the present disclosure; and

FIG. 5 is a schematic diagram of the electric power steering system and the vehicle control system in a third embodiment of the present disclosure.

### DETAILED DESCRIPTION

### First Embodiment

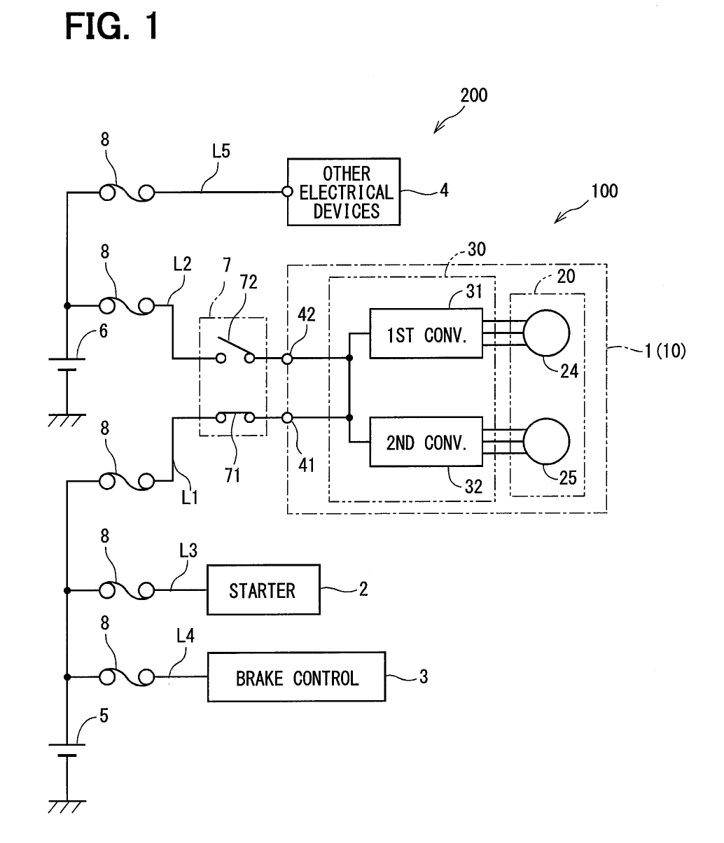

An electric power steering system 100 and a vehicle control system 200 according to the first embodiment of the present disclosure are described with reference to FIGS. 1-3.

(Vehicle Control System 200)

First, an outline of the vehicle control system 200 is described. The vehicle control system 200 is a system in a vehicle, organizing in-vehicle devices providing basic functions such as “running, steering, and stopping,” and other devices providing other functions such as a power supply function and the like.

More specifically, the vehicle control system 200 is provided with an electric power steering device 1, a starter 2, a brake controller 3, the other in-vehicle devices 4, batteries 5, 6, and a power switcher 7 and the like, as shown in FIG. 1.

The electric power steering device 1 is a power assist device for assisting a drivers steering operation, and provides, or “guarantees,” a steering function. The starter 2 is a device for starting an engine, providing a “running” function. The brake controller 3 is a device for braking the vehicle, providing a “stopping” function, and is realized as at least one of an anti-lock brake system (ABS), a traction control system (TCS), and an anti-skid brake system (ESC).

The other in-vehicle devices 4 are devices providing other functions, other than the basic functions. For example, the other in-vehicle devices 4 may be a vehicle navigation device, a headlamp, an air-conditioner and the like. In other words, in the present embodiment, the other in-vehicle devices 4 may be any device other than the electric power steering device 1, the starter 2, and the brake controller 3.

Although the drawing in FIG. 1 illustrates the other in-vehicle devices 4 as only one device, the other in-vehicle devices 4 may be plural devices.

The batteries 5, 6 are, respectively, a direct-current power supply of 12V, for example, and one of them is designated as a first battery 5 and the other one of them is designated as a second battery 6. The electric power steering device 1, the starter 2, and the brake controller 3 are connected to the first battery 5 in parallel. The other in-vehicle devices 4 and the electric power steering device 1 are connected to the second battery 6 in parallel. The power switcher 7 is disposed at a position between the batteries 5, 6 and the electric power steering device 1, and the power switcher 7 selectively connects one of the first battery 5 or the second battery 6 to the electric power steering device 1. In other words, the electrical connection between (i) the batteries 5, 6 and (ii) the steering device 1 is established and is removed by the switcher 7.

The power switcher 7 connects the first battery 5 and the electric power steering device 1 when the first battery 5 is normally operating. At such time, the first battery 5 supplies electric power to the electric power steering device 1, the starter 2, and the brake controller 3, and the second battery 6 supplies electric power to the other in-vehicle devices 4. That is, in the vehicle control system 200, the basic function providing devices and the other devices do not share the power supply when the electric power is normally supplied.

A fuse 8 is disposed on each of power supply lines L1-L5, which supply electric power from the batteries 5, 6 to the electric power steering device 1, to the starter 2, to the brake controller 3, and to the other in-vehicle devices 4. The fuse 8 can intercept a supply of electric power, when failure, e.g., a short circuit etc., is caused in a device connected to the power supply line and an overcurrent flows therein.

(Electric Power Steering System 100)

Next, the details of the electric power steering system 100 in the vehicle control system 200 are described with reference to FIG. 1. The electric power steering system 100 includes, among the above-described devices, the electric power steering device 1, the batteries 5, 6, and the power switcher 7.

Two power supply connectors 41, 42 for electrical connection with the exterior are provided in the electric power steering device 1. The first battery 5 is electrically connected to one of them, i.e., to the connector 41 (hereafter designated as the first power supply connector 41) and the second battery 6 is electrically connected to the other one of them, i.e., to the connector 42 (hereafter designated as the second power supply connector 42).

The power switcher 7 comprises a first switch relay 71 disposed on the power supply line L1 between the first battery 5 and the first power supply connector 41, and a second switch relay 72 disposed on the power supply line L2 between the second battery 6 and the second power supply connector 42. The first switch relay 71 can electrically connect or intercept the first battery 5 and the first power supply connector 41. The second switch relay 72 can electrically connect or intercept the second battery 6 and the second power supply connector 42.

The first switch relay 71 and the second switch relay 72 may be respectively implemented as a semiconductor switching element, a mechanical relay, etc., e.g., as a Metal Oxide Semiconductor Field Effect Transistor (MOSFET) or an Insulated-Gate Bipolar Transistor (IGBT), for example.

The power switcher 7 is controlled by a high-level system higher than the switcher 7 and the batteries 5, 6, e.g., an Engine Control Unit (ECU), which is capable of detecting abnormality of the first battery 5, and controls the first switch relay 71 to be conductive and controls the second switch relay 72 to be interceptive when the first battery 5 is normally operating (i.e., at a normal time). At the normal time, the electric power is supplied to the electric power steering device 1 from the first battery 5. On the other hand, at an abnormal time, i.e., when abnormality of the first battery 5 is detected, the first switch relay 71 is intercepted and the second switch relay 72 becomes conductive. At such a time, the electric power is supplied to the electric power steering device 1 from the second battery 6.

(Electric Power Steering Device 1)

Next, the electric configuration of the electric power steering device 1 is described with reference to FIG. 1. In FIG. 1, a part of the configuration is simplified.

The electric power steering device 1 is provided with a motor 20, a controller 30, the first power supply connector 41, and the second power supply connector 42. The electric power steering device 1 may be a column assist type or may also be a rack assist type, and outputs a steering assist torque and transmits it to a column or a rack via a speed reduction gear which is not illustrated based on control signals representing a steering torque and a travel speed from the motor 20.

The motor 20 is a three-phase brushless motor, and has a first winding group 24 and a second winding group 25 that are respectively wound on the stator 23 to be mentioned later.

The first winding group 24 and the second winding group 25 comprise a U phase coil, a V phase coil, and a W phase coil, respectively.

The controller 30, which is different from the brake controller 3 described earlier, may be an ECU, for example, and is provided with a first inverter 31, a second inverter 32, a control unit that is not illustrated, together with other parts.

The first inverter 31 and the second inverter 32 are constructed as a bridge connection of six switching elements (not shown), respectively. The switching elements may be implemented as a MOSFET, an IGBT, etc., for example.

The first inverter 31 is connected to the first winding group 24, and the second inverter 32 is connected to the second winding group 25. The first inverter 31 applies an alternating current to the first winding group 24 based on a control signal, and the second inverter 32 applies an alternating current to the second winding group 25 based on a control signal. Thereby, the motor 20 is driven.

According to the present embodiment, a combination of the first winding group 24 and the first inverter 31 corresponding thereto is designated as a first system, and a combination of the second winding group 25 and the second inverter 32 corresponding thereto is designated as a second system. That is, drive control of the motor 20 is performed with plural systems (i.e., with two systems in the present embodiment).

The first system and the second system are provided in parallel with each other in association with the first and second power supply connectors. That is, the first power supply connector 41 supplies electric power to the first system, and the second power supply connector 42 to the second system respectively.

(Drive Unit 10)

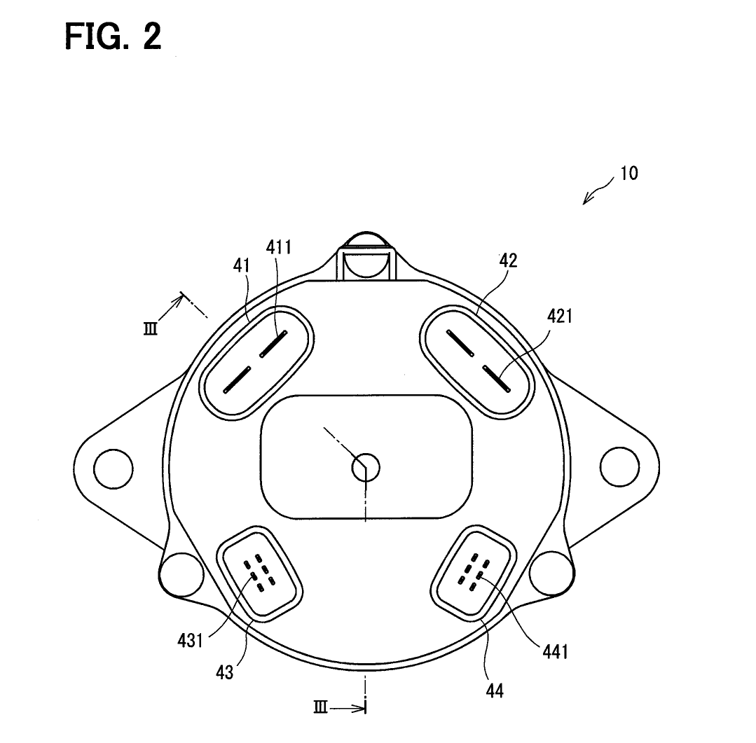

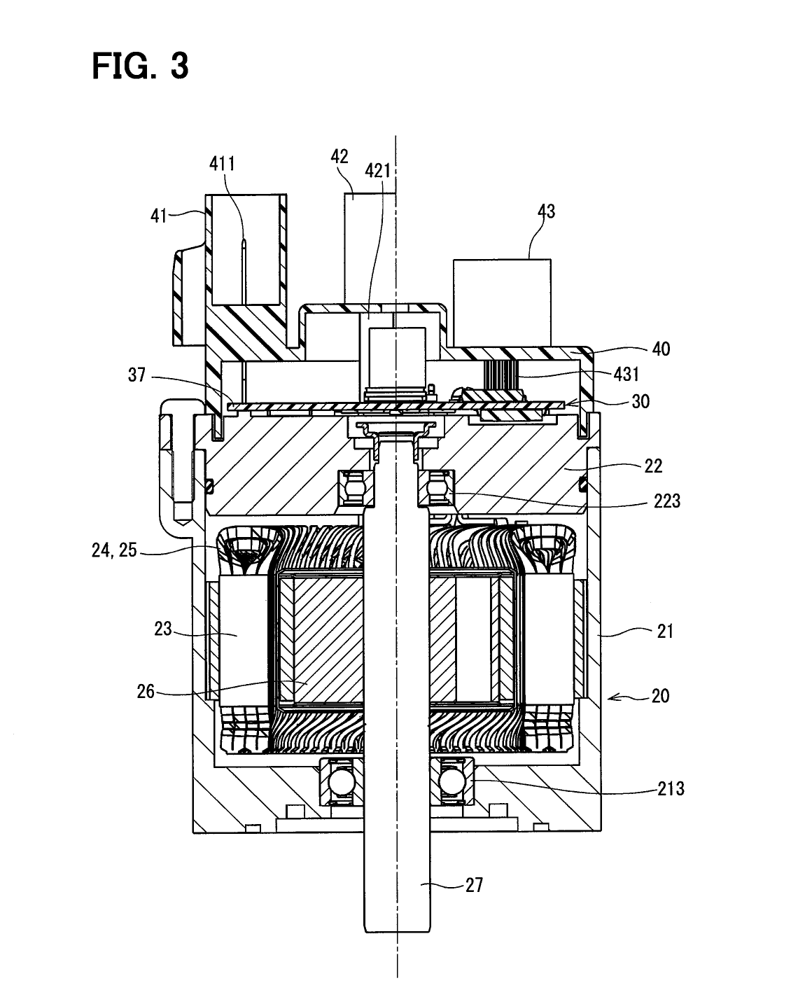

The motor 20, the controller 30, the first power supply connector 41, and the second power supply connector 42 mentioned above are integrated as one to drive unit 10. Hereafter, a structure of the drive unit 10 is described based on FIGS. 2 and 3. The “axial direction” in the following description basically means an axial direction of the shaft of the motor 20, and the “radius direction” in the following basically means a direction along a radius of the motor 20.

The motor 20 is provided with a motor case 21, a frame 22, a stator 23, the first winding group 24, the second winding group 25, a rotor 26, a shaft 27 and the like.

The motor case 21 has a closed-end cylinder shape, for example, and is made with metal, e.g. aluminum. The frame 22 is fixed onto an opening of the motor case 21 by a screw or the like. The frame 22 bears, i.e., shoulders, a substrate 37 which serves as the controller 30 on an opposite side, i.e., a side opposite to and not facing the motor case 21.

The stator 23 is fixed in an inside of the motor case 21. The first winding group 24 and the second winding group 25 are wound on the stator 23. From each phase of the first winding group 24 and the second winding group 25, a motor line is taken out, and the motor line extends via the frame 22 toward the substrate 37.

The rotor 26 is coaxially disposed inside the stator 23, i.e., inside along a radius direction. The shaft 27 is formed in a rod shape with metal, for example, and is fixed at an axial center of the rotor 26. The shaft 27 is rotatably held by bearings 213 and 223 disposed on the motor case 21 and on the frame 22. Thereby, the shaft 27 and the rotor 26 rotate together.

The controller 30 is provided as various electronic components, e.g. a MOSFET, a capacitor, and the like implemented on the substrate 37. According to the present embodiment, the electronic components serving as the controller 30 are mounted on one substrate 37. By putting the components on one substrate 37, the total number of components in the controller 30 is reduced, and, at the same time, the volume of the controller 30 is also reduced. The substrate 37 is arranged on one side of the frame 22, and the motor 20 is arranged on the opposite side thereof.

A cover 40 is disposed on the opposite side of the frame 22 relative to the substrate 37. The cover 40 is disposed to cover an upper part of the substrate 37, and is fixed by adhesives etc. to the frame 22. Further, the cover 40 has the first power supply connector 41, the second power supply connector 42, and two signal connectors 43, 44. The first power supply connector 41, the second power supply connector 42, and the two signal connectors 43, 44 are disposed on the cover 40 projecting away from the motor 20.

The first power supply connector 41 is configured to be connectable to a harness, which is not illustrated and extends along the axial direction to be connected to the first battery 5, and has a first power supply connector terminal 411 which is connected to the substrate 37.

The second power supply connector 42 is configured to be connectable to a harness which is not illustrated and extends along the axial direction to be connected to the second battery 6, and has a second power supply connector terminal 421 which is connected to the substrate 37.

The first power supply connector terminal 411 and the second power supply connector terminal 421 are inserted into a terminal insertion hole which is disposed on the substrate 37 and which is not illustrated, and are electrically connected to the substrate 37 by solder etc. Thereby, the first battery 5 and the second battery 6 are connectable to the controller 30.

The two signal connectors 43, 44 are configured to be connectable to a harness which is not illustrated and extends along the axial direction to be connected to in-vehicle sensors and the like, and have signal connector terminals 431, 441 connected to the substrate 37. Thereby, the signal from the outside is inputted into the controller 30. The signal connector terminals 431, 441 is inserted into terminal insertion holes which are disposed on the substrate 37 and which are not illustrated, and is electrically connected to the substrate 37 by solder etc.

In the present embodiment, various electronic components are arranged inside portion of the substrate 37, and the first power supply connector terminal 411, the second power supply connector terminal 421, and the signal connector terminals 431, 441 are arranged at a periphery of the substrate 37. In such manner, the implementation area of the substrate 37 is efficiently used, enabling four connectors 41, 42, 43, 44 arranged on one substrate 37.

(Effect of the Present Disclosure)

As described in full details above, the electric power steering system 100 to of the present embodiment is provided with the electric power steering device 1, the first battery 5, the second battery 6, and the power switcher 7. The electric power steering device 1 has the motor 20, the controller 30, the first power supply connector 41, and the second power supply connector 42. The first power supply connector 41 electrically connects the controller 30 to the power supply line L1 which extends from the first battery 5. The second power supply connector 42 electrically connects the controller 30 to the power supply line L2 which extends from the second battery 6.

The electric power may be supplied from the first battery 5 to the electric power steering device 1, and the electric power may be supplied from the second battery 6 to the electric power steering device 1 and to the other in-vehicle devices 4.

The power switcher 7 is provided at a position between the batteries 5, 6 and the power supply connectors 41, 42, and selectively connects the first battery 5 or the second battery 6 to the electric power steering device 1 for the supply of the electric power.

In the present embodiment, the power switcher 7 connects the first battery 5 and the electric power steering device 1 when the electric power supply from the first battery 5 is normal, and connects the second battery 6 and the electric power steering device 1, when abnormality is caused in the electric power supply from the first battery 5.

According to the above-mentioned configuration, the power supply lines L1, L2 from the first battery 5 and the second battery 6 to the power supply connectors 41 and 42 are provided as entirely separate, two independent lines. Therefore, when abnormality is caused in one line, i.e., in the power supply line L1, the electric power may still be supplied to the controller 30 with the other line, via the power supply line L2. Therefore, the supply of the electric power supply to the electric power steering device 1 is enabled to be completely redundant.

According to the above-mentioned configuration, when the first battery 5 is normally operating, the electric power is supplied to the electric power steering device 1 from the first battery 5, and is supplied to the other in-vehicle devices 4 from the second battery 6. That is, the electric power is supplied to the electric power steering device 1 and to the other in-vehicle devices 4 from respectively different sources, i.e., from the battery 5 and from the battery 6. Therefore, even when the motor 20 of the electric power steering device 1 generating a steering assist torque consumes a big electric power, the other in-vehicle devices 4 will not be affected. In other words, the fluctuation of the electric power will not be caused for the other devices 4. Further, in comparison to the conventional technique, in which the electric power steering device 1 shares only one supply of the electric power with the other in-vehicle devices 4, the electric power steering device 1 of the present disclosure can allocate and consume a larger amount of the electric power.

According to the present embodiment, the motor 20 has the first winding group 24 and the second winding group 25, and the controller 30 has the first inverter 31 corresponding to the first winding group 24 and the second inverter 32 corresponding to the second winding group 25.

Thereby, the drive control of the motor 20 is performed by using two systems, i.e., by using the first system including the first winding group 24 and the first inverter 31 by using the second system including the second winding group 25 and the second inverter 32. That is, even when the winding group or the inverter in one system or the other fails, the drive of the motor 20 may still continue with the other system, i.e., by using a normally-operating system.

Therefore, the electric power steering system 100 of the present embodiment has a completely redundant electric power supply system, i.e., two or duplex lines, between the batteries 5, 6 and the motor 20.

In the present embodiment, the power switcher 7 includes the first switch relay 71 on the power supply line L1 connecting the first battery 5 and the first power supply connector 41 and the second switch relay 72 on the power supply line L2 connecting the second battery 6 and the second power supply connector 42. Thereby, the power switcher 7 can appropriately connect and disconnect, i.e., conduct and intercept, the power supply lines L1 and L2 at a position between the first battery 5 and the electric power steering device 1 or at a position between the second battery 6 and the electric power steering device 1.

In the present embodiment, the motor 20, the controller 30, the first power supply connector 41, and the second power supply connector 42 are integrated to provide the drive unit 10 in one body. Therefore, the electric power supply to the drive unit 10 is completely redundant.

The vehicle control system 200 of the present embodiment is provided with the electric power steering system 100, the starter 2, and the brake controller 3. The first battery 5 is capable of providing electric power to the starter 2 and the brake controller 3, in addition to the motor 20 of the electric power steering device 1.

Therefore, even when the basic functions of the vehicle under control of the electric power steering device 1, the starter 2, and the brake controller 3 used, i.e., when a large electric power is used for those functions, the other in-vehicle devices 4 are free from electric power fluctuation or the like. Further, a large amount of electric power is usable by these devices.

Even in case, for example, the second battery 6 runs down due to the headlamp (i.e., one of the other in-vehicle devices 4) being left turned on after the parking of the vehicle, the starter 2 is still operable (by the battery 5), enabling the travel of the vehicle.

### Second Embodiment

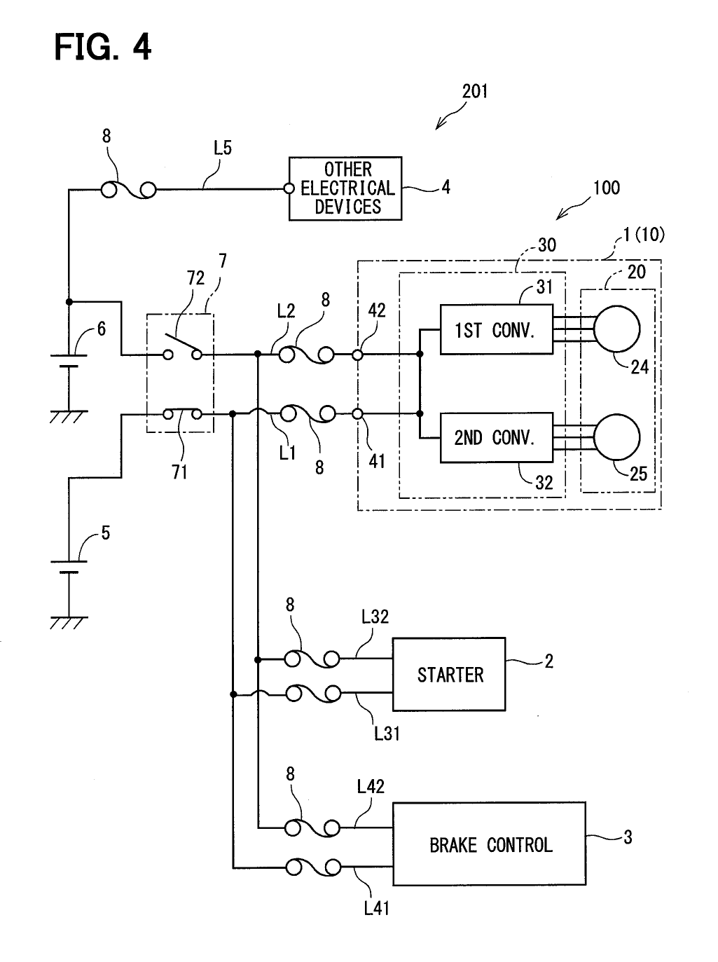

A vehicle control device 201 in the second embodiment of the present disclosure is shown in FIG. 4. The vehicle control device 201 is different from the above-described embodiment in that not only the electric power steering device 1 but also the starter 2 and the brake controller 3 are connected to the power switcher 7.

According to the present embodiment, two power supply lines L31 and L32 are connected to the starter 2. One of the two lines, i.e., the power supply line L31, is connected to the first switch relay 71 of the power switcher 7, and the other line, i.e., the power supply line L32, is connected to the second switch relay 72 of the power switcher 7.

Further, two power supply lines L41 and L42 are connected to the brake controller 3. One of the two lines, i.e., the power supply line L41, is connected to the first switch relay 71 of the power switcher 7, and the other line, i.e., the power supply line L42, is connected to the second switch relay 72 of the power switcher 7.

The fuse 8 is disposed on each of the power supply lines L31, L32, L41, and L42.

Further, the fuse 8, provided at a position between each of the batteries 5, 6 and the power switcher 7 on the power supply lines L1 and L2 in the first embodiment, is provided in the present embodiment at a position between the power switcher 7 and the electric power steering device 1.

Control of the power switcher 7 in the present embodiment is the same as the first embodiment. That is, when the first battery 5 is normally operating, the first switch relay 71 is conducted, and the second switch relay 72 is intercepted. By such control, electric power is supplied to the electric power steering device 1, to the starter 2, and to the brake controller 3 from the first battery 5 in the present embodiment.

Further, when the first battery 5 is abnormal, the first switch relay 71 is intercepted and the second switch relay 72 is conducted. By such control, electric power is supplied to the electric power steering device 1, to the starter 2, and to the brake controller 3 from the second battery 6 in the present embodiment.

Therefore, in the present embodiment, the power supply to the electric power steering device 1, to the starter 2, and to the brake controller 3 is simultaneously switched among the batteries 5, 6, i.e., from one battery to the other battery, by the control of the power switcher 7.

### Third Embodiment

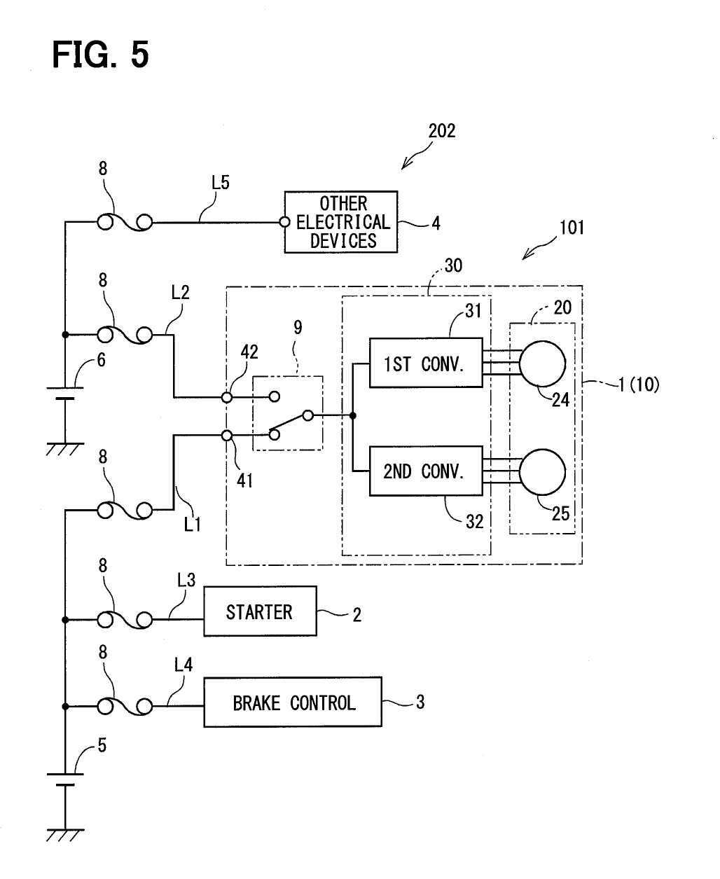

A vehicle control device 202 using an electric power steering system 101 in the third embodiment of the present disclosure is shown in FIG. 5. The focus of the present embodiment is a power switcher 9 of the electric power steering system 101 which is different from the power switcher 7.

The power switcher 9 differs from the power switcher 7 of the first embodiment, i.e., is disposed in the electric power steering device 1. The power switcher 9 is a single-pole double-throw type relay, and can electrically connect one of the first power supply connector 41 and the second power supply connector 42 to the controller 30, for example. Further, the power switcher 9 may be constructed from a semiconductor switching element, a mechanical relay, etc., e.g. a MOSFET, an IGBT, or the like, and may be disposed on the substrate 37 of the drive unit 10 together with the controller 30.

The power switcher 9 is controlled by a high level system, e.g., an ECU which can detect the abnormality of the first battery 5.

For example, when the first battery 5 is normally operating, the power switcher 9 conducts a line between the first power supply connector 41 and the controller 30. At such time, electric power is supplied to the controller 30 from the first battery 5. Further, when the first battery 5 is abnormal, the power switcher 9 conducts a line between the second power supply connector 42 and the controller 30. At such time, electric power is supplied to the controller 30 from the second battery 6.

In the electric power steering system 101 of the present embodiment, a redundancy of the electrical system from the first battery 5 and the second battery 6 to the drive unit 10 of the electric power steering device 1 is provided.

### Other Embodiment

Although the present disclosure has been described in connection with preferred embodiment thereof with reference to the accompanying drawings, it is to be noted that various changes and modifications will become apparent to those skilled in the art.

(a) In the above-mentioned embodiments, the motor 20 is a three phase brushless motor. In other embodiments, the motor 20 may be other types, e.g., a DC brushed motor or any other type.

(b) In the above-mentioned embodiments, the batteries 5, 6 are described as 12V power supply, for example. The voltage value is not necessarily limited to the above, and the two batteries may have respectively different voltages.

(c) In the above-mentioned embodiments, two power systems are used, in which the winding group of the motor 20 and an inverter is combined. In other embodiments, three or more power systems may be provided, or only one power system is provided.

(d) In the above-mentioned embodiments, the electric power steering device 1 has two power supply connectors 41 and 42, which may be three or more connectors in other embodiments. Further, the electric power steering systems 100 and 101 may have three or more batteries for respectively supplying electric power to three or more power supply connectors of the electric power steering device 1.

(e) In the above-mentioned embodiments, the electric power steering device 1, the starter 2, and the brake controller 3 are connected to the first battery 5, which may be changed in other embodiments, i.e., the electric power steering device 1 should only be connected to the first battery 5. Alternatively, the electric power steering device 1 and at least one of the starter 2 and the brake controller 3 may be connected to the first battery 5.

(f) In the second embodiment, both of the starter 2 and the brake controller 3 are connected to the power switcher 7, which may be changed in other embodiments, i.e., one of the starter 2 and the brake controller 3 may be connected to the power switcher 7.

(g) In the third embodiment, the power switcher 9 is not necessarily limited to a single-pole double-throw type relay, but may also be constructed from two relays just like the first embodiment.

(h) In the above-mentioned embodiments, the starter 2 and the brake controller 3 are not included in the other in-vehicle devices 4, the present disclosure is not limited to such configuration. In other embodiments, the starter 2 and the brake controller 3 may be included in the other in-vehicle devices 4 instead of separately provided from the other in-vehicle devices 4.

As mentioned above, the present disclosure is not limited to such an embodiment and can be performed with various forms in the range which does not deviate from the meaning of invention.

Such changes, modifications, and summarized scheme are to be understood as being within the scope of the present disclosure as defined by appended claims.

What is claimed is:

1. An electric power steering system comprising:
an electric power steering device including an electric motor, a controller controlling the motor, and two power supply connectors, for assisting a steering operation of a vehicle;
a first power supply supplying power to a first connector;
a second power supply supplying power to a second connector and to other in-vehicle devices other than the electric power steering device; and
a power switcher provided en route to the controller, to electrically to connect the first power supply to the controller when power supply from the first power supply is normal, and to electrically connect the second power supply to the controller when the power supply from the first power supply is abnormal.

2. The electric power steering system of claim 1, wherein
the electric motor has plural sets of winding groups, each of the plural sets of winding groups having plural windings, and
the controller has plural inverters respectively corresponding to the plural sets of winding groups.

3. The electric power steering system of claim 2, wherein
the plural inverters are arranged in parallel with each other in association with the two power supply connectors.

4. The electric power steering system of claim 1, wherein
the electric motor, the controller and the two power supply connectors are integrated in one body.

5. The electric power steering system of claim 1, wherein
the power switcher is provided as a first relay between the first power supply connector and the first power supply and as a second relay between the second power supply connector and the second power supply.

6. The electric power steering system of claim 1, wherein
the power switcher is provided as a relay disposed at a position between the two power supply connectors and the controller and selectively conducting one of the two supply connectors to the controller.

7. A vehicle control system comprising:
an electric power steering system comprising:
an electric power steering device including an electric motor, a controller controlling the motor, and two power supply connectors, for assisting a steering operation of a vehicle;
a first power supply supplying power to a first connector;
a second power supply supplying power to a second connector and to other in-vehicle devices other than the electric power steering device; and
a power switcher provided en route to the controller, to electrically connect the first power supply to the controller when power supply from the first power supply is normal, and to electrically connect the second power supply to the controller when the power supply from the first power supply is abnormal; and
at least one a starter starting an internal combustion engine and a brake control, wherein
the first power supply further supplies power to at least one of the starter and the brake control.

8. A vehicle control system comprising:
an electric power steering system comprising:
an electric power steering device including an electric motor, a controller controlling the motor, and two power supply connectors, for assisting a steering operation of a vehicle;
a first power supply supplying power to a first connector;
a second power supply supplying power to a second connector and to other in-vehicle devices other than the electric power steering device; and
a power switcher provided en route to the controller, to electrically connect the first power supply to the controller when power supply from the first power supply is normal, and to electrically connect the second power supply to the controller when the power supply from the first power supply is abnormal; and
at least one a starter starting an internal combustion engine and a brake control, wherein
the power switcher electrically connects the controller of the electric power steering device and at least one of the starter and the brake control to the to first power supply when the power supply from the first power supply is normal, and
the power switcher electrically connects the controller of the electric power steering device and at least one of the starter and the brake control to the second power supply when the power supply from the first power supply is abnormal.
